(19) United States
(12) Patent Application Publication
(10) Pub. No.: US 2023/0108068 A1
(43) Pub. Date: Apr. 6, 2023

(54) Traffic Signal Polarized Green-Wave Control Method

(71) Applicant: Weiping Meng, Flushing, NY (US)

(72) Inventor: Weiping Meng, Flushing, NY (US)

(21) Appl. No.: 17/907,983

(22) PCT Filed: Mar. 2, 2020
(86) PCT No.: PCT/CN2020/000041

§ 371 Date: Sep. 5, 2022

(51) Int. Cl. G08G 1/083; G06N 20/00

(52) U.S. Cl. CPC G08G 1/083; G06N 20/00

(57) ABSTRACT

The invention concerns traffic signal control, is optimized period and green time ratio green wave control method, main steps includes: 1) build polarized period spectrum; 2) decide polarized period spectrum tactics; 3) AI optimized polarized period spectrum; 4) configure polarized green-wave interim and period; 5) run polarized green-wave, including differential green-wave and optimization time interval; Advantage: both provides concrete signal scheme/control methods of broad band traffic signal period/green time ratio to road-net that spreads very heavy traffic at some intersections of non-uniform traffic loads, and an interface frame for obtaining and dealing with traffic data/optimizing signals' parameters using AI tech dynamically on line; comparing to current traffic signal systems, waiting time is lessened by far more than 30%, efficiency of transportation is improved greatly; whose attributes as universal model easy to embed new signal technology such as Pan String, String Super-mode, Lined Mixture, Pan-Green-Wave, differential green-wave, and whose frame features embedding AI's methods may realize wider gain of double broadband, including special signals for bus, application prospect is broad.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention relates to a traffic control method, particularly to traffic signal green wave method for non-uniform traffic load in a road-net.

Currently many two dimension based traffic signal green-wave modes are invented including String super mode, decreasing traffic time in area four directions traffic. However, in reality, there are quite much amount of non-uniform traffic, and peak traffic load distributed at some intersections, needing related more efficient signal modes to handle.

### BRIEF SUMMARY OF THE INVENTION

It is an object of the present invention to design traffic green-wave mode in order to handle non-uniform traffic loads distributed in road-net, decrease traffic waiting time, improve the efficiency of traffic.

The present invention, with help of new signals' technologies including String, pan-green-wave, real-time moding, differential green-wave, propose so-call polar green-wave control method that optimize multi extreme period and phase ratio, dynamically on-line.

A traffic signal polarized green-wave control method includes steps:

S1, get parameters of every intersection and distance/traffic time of every road-segment of a road-net;

S2, configure polarized green-wave mode: (1) obtain parameters of polarized green wave: 1) specify optimization algorithm of intersection signal, ratio-rules-based signal's parameters, period/green time ratio, traffic data used and their obtained method including artificial intelligence (AI) method, optimization time interval; 2) specify method for obtaining and optimizing vehicle queues of intersection; 3) specify mode and relative parameters; 4) specify additional time for the traffic time of road-segments;

(2) build polarized period spectrum P^{e}_{m,n}: 1) according to specified optimization time interval, obtained traffic data, signal parameters, optimization algorithm, calculate phases' time and ratio-rules' parameters of every intersection, as result, periods P_{m,n} of every intersection are obtained, where m, n are coordinates of an intersection in road-net; 2) take sum of two biggest phase times Tₘ₋ₘₐₓ, Tₙ₋ₘₐₓ among all period P_{m,n} of two cross directions as polarized period P₀; 3) divide the polarized period P₀ into series of sub-periods, Pₘₐₓ/1, Pₘₐₓ/2, Pₘₐₓ/3 (or Pₘₐₓ/4), . . . , as period spectrum of the polarized period, or say polarized period spectrum, which satisfy requirement of minimum period; 4), magnifying period P_{m,n}, of every intersection to the one of the period spectrum that is closest to the P_{m,n}, or using the polarized period spectrum directly, make periods P_{m,n}^{e} of every intersection with corresponding phase ratios;

(3) decide tactics of the polarized periods: multi periods distribution, single period, multi periods compatible, or other comprehensive tactics;

(4) predict polarized periods optimized: predict, re-optimize, re-configure current signals parameters, periods P_{m,n} with their green time ratios, and polarized periods P^{e}_{m,n}, in term of specified mode and its parameters, α artificial intelligence method;

(5) configure the polarized periods and their interim periods: 1) based on specified parameters of the mode and the optimization tactics, compute traffic time of every road-segment, or, mode-specified road-net eigen period P^{β}; 2) based on specified parameters, obtain vehicle queues of every intersection, and compute intersection-queue time offsets trq of every vehicle queue based on intersection-queue time offsets law of pan-green-wave; 3) based on specified mode and parameters, the optimization tactics, and the intersection-queue time offsets trq of the vehicle queues of every road-segment, compute time offsets of polarized green-wave; 4) make interim of polarized green-wave using remainder of the polarized green-wave time offsets;

S3, Run the polarized green-wave mode after running out the respective interim period of every intersection; meanwhile,

(1) differential green-wave: when differential green-wave starts, run differential signals operations with differential green-wave sensors catching differentiable traffic information;

(2) optimization time interval: when optimization time interval starts, run “build period spectrum P^{e}_{m,n} of the polarized green wave”;

Said road-net is a group of mutually crossing roads, wherein its crossing points with their every directions controlled with traffic signals, called as intersections, divide the roads into groups of road-segments, parallelly topologically;

Said ratio-rules' signal bases on a cycle time length so-called period and ratios dividing the period into traffic signals controlling phases, directions and straight/left/right, where the period is traffic signal phases' times' sum of every directions controlled of an intersection; when all intersections' traffic signals in an area run on ratio-rules synchronously, it is called mode RATIO;

Said artificial intelligence (AI) method includes Artificial Neuron Networks ANN, Chaos Time Series, Wavelet theory, Statistical Regression and Support Vector Machine SVM, Genetic Optimization GA, Particle Swarm Optimization PSO, Fuzzy Analysis and Information Granulation, A-A method, intelligence learning time-series analysis method, any predict/optimization method including empirical method; what are obtained by AI methods analyzing historical data and detected data in real time are intelligent data;

Said green-wave means such signal mode that traffic signal green lights among intersections based on said ratio-rule and preset orderly time-offsets run asynchronously, making green light signal propagate between intersections directionally, from a source intersection to the intersection's adjacent one with bigger time-offset; a green-wave with its propagating direction same as traffic direction controlled is Lead mode, one with its propagating direction reverse of traffic direction controlled is Release mode, including uni-direction one dimension green-wave, convection one dimension green-wave, cross bi-direction two dimension green-wave, convection two dimension green-wave, out-phase mixed lined green-wave; RATIO is a standing green-wave; said source intersection is an intersection of a green-wave set smallest time-offset comparing with all the other intersections in the green-wave road-net; source intersections of uni-direction green-wave, convection one dimension green-wave and out-phase mixed lines green-wave are at one end intersections of their green-wave channels, and source intersections of cross bi-directions green-wave and cross convection cross 4-directions green-waves are at corner intersections of their green-waves area;

Said interim period is sum of traffic signal green light interim times in all directions controlled, is period remainder of switch time-offset of new mode comparing with current mode, in which traffic signal mode of an intersection changes from current mode to new mode smoothly without redundant time; Said remainder is period remainder, =remainder (time−offset % period); Said complement is period complement, =period−remainder; Said time-off is a delay of an intersection period comparing with a mode source intersection period, related to cared distance and traffic time, is sum of all related road-segments' traffic times from a source intersection of a green-wave to a specified downstream intersection of the green-wave;

Another feature of the traffic signal polarized green-wave control method, is step S2 including: S21, obtain parameters of polarized green wave: 1) specify optimization algorithm of intersection signal, ratio-rules-based signal's parameters, period/green time ratio, traffic data used and their obtained method including artificial intelligence (AI) method, optimization time interval; 2) specify method for obtaining and optimizing vehicle queues of intersection; 3) specify mode and relative parameters; 4) specify additional time for traffic time T_{m,n}(v, T_{*}) of road-segments;

Said optimization algorithm of intersection signal, includes Webster Timing Method, Conflict point method, estimation method, or critical Lane method;

Said traffic data and method obtaining traffic data, includes historical (medium and long term) data data_cc, measured data data_pb and differential green-wave data data_ph by traffic data detectors in real time, AI-based obtained traffic data, arrival volume, vehicle queues, distance between vehicle heads; said optimization time interval includes calendar hours, signal period, differential green-wave time, and their mixture;

Said traffic time T_{m,n}(v, T_{*}), includes set drive time or/and additional time T_{*} that is function T_{m,n}(v, T_{*}) of set drive speed v or/and additional time T_{*}; set drive time equals to time when vehicle drive through whole road-segment at set drive speed, the additional time T_{*} include queue time T_{queue} at intersection, other time such as bus stop time Tₛₜₒₚ added when required;

Said method for obtaining and optimizing vehicle queues of intersection, includes intersection-queue time offsets trq of the vehicle queues and intersection based on intersection-queue time offsets law of pan-green-wave, counting vehicle heads, specified probability, and their mixture; way for obtaining vehicle queues of intersection includes historical (medium and long term) data, measured by traffic data detectors in real time, or their mixture, also including Webster Timing Method, Conflict point method, estimation method, critical Lane method, A-A algorithm-based prediction, and other AI-based method;

Said mode and relative parameters, including uni-direction green-wave, convection one dimension green-wave, bi-direction two dimension green-wave, convection two dimension green-wave, or out-phase mixed line green-wave, source intersection position, Lead, Release, eigen period P^{t}, and other related parameters;

Said traffic data detectors, including positioning devices such as mobile phone/satellite, traffic video, induction coils, magnetic induction, infra-red/ultrasonic, radars, are used to detect every phase traffic data (multi lanes sharing same phase or one lane controlled for multi phases), traffic flow, vehicle arrival volume, vehicle queue, vehicle speed, vehicle type, vehicle-between distance, vehicle queue tail data_qb;

Another feature of the traffic signal polarized green-wave control method, is step S2 including: S22, build polarized period spectrum P^{e}_{m,n}: 1) according to specified optimization time interval, obtained traffic data, signal parameters, optimization algorithm, calculate phases' time and ratio-rules' parameters of every intersection, as result, periods P_{m,n} of every intersection are obtained, where m, n are coordinates of an intersection in road-net; 2) take sum of two biggest phase times Tₘ₋ₘₐₓ, Tₙ₋ₘₐₓ among all period P of two cross directions as polarized period P₀; 3) divide the polarized period P₀ into series of sub-periods, Pₘₐₓ/1, Pₘₐₓ/2, Pₘₐₓ/3 (or Pₘₐₓ/4), . . . , as period spectrum of the polarized period, or say polarized period spectrum, which satisfy requirement of minimum period; 4), magnifying period P_{m,n} of every intersection to the one of the period spectrum that is closest to the P_{m,n}, or using the polarized period spectrum directly, make periods P^{e}_{m,n} of every intersection with corresponding phase ratios.

Another feature of the traffic signal polarized green-wave control method, is step S2 including: S23, decide tactics of the polarized periods are rules of choice of which group of periods of polarized period spectrum are used to base configuring green-wave time-offsets in order to optimize traffic time: multi periods distribution, single period, multi application period compatible, or other comprehensive tactics;

Another feature of the traffic signal polarized green-wave control method, is step S2 including: S24, predict polarized periods optimized: predict, re-optimize, re-configure current signals parameters, periods P_{m,n} with their green time ratios, and polarized periods P^{e}_{m,n}, in term of specified mode and its parameters, α artificial intelligence method; said α artificial intelligence method is specially used to further optimize intersection signal parameters already optimized by traffic data.

Another feature of the traffic signal polarized green-wave control method, is step S2 including: S25, configure the polarized periods and their interim periods: 1) based on specified parameters of the mode and the optimization tactics, compute traffic time T_{m,n}(v, T_{*}) of every road-segment, or, mode-specified road-net eigen period P^{β}; 2) based on specified parameters, obtain vehicle queues of every intersection, and, compute intersection-queue time offsets trq of every vehicle queue based on intersection-queue time offsets law of pan-green-wave; 3) based on specified mode and parameters, the optimization tactics, and the intersection-queue time offsets trq of the vehicle queues of every road-segment, compute time offsets of polarized green-wave; 4) make interim of polarized green-wave using remainder of the polarized green-wave time offsets;

Said road-net eigen period P^{β} means road-net feature related signal period required by special signal modes, for an example, convection signal mode requires period integer multiple of road-net eigen period; assume road-net eigen period P^{β}, where β is smaller than or equal to 100, stands for the period P^{β}'s percentage similarity to theoretical eigen period, such as β=85, means period P^{β} is 85% similarity to theoretical eigen period, β=100 means theoretical eigen period; P^{β} are a function P^{β}(v, T_{*}) of set drive speed v and additional time T_{*}.

Another feature of the traffic signal polarized green-wave control method, is step S2 including: S23-1-1, said multi periods distribution of polarized period's tactics, means that based on one period of polarized period spectrum configure some other periods of the polarized period spectrum distributed to intersections around road-net, construct embedded local green-wave in basic period green-wave.

Another feature of the traffic signal polarized green-wave control method, is step S2 including: S23-1-2, Said multi periods compatible of polarized period's tactics, means that based on one period of period spectrum, configure some other periods of the period spectrum distributed to intersections around road-net, construct embedded convection green-wave whose period are integer multiples of basic green-wave period forming multi global green-waves compatible, in term of road-net features and traffic features, for special application with special drive speed v and additional time T_{*} of special traffic time T_{m,n}(v, T_{*}), such as bus speed, bus stop positions and bus stop time.

Another feature of the traffic signal polarized green-wave control method, is step S2 including: S25-1, configure convection two dimension polarized green-wave periods and their interim periods: 1) based on specified parameters of the mode and the optimization tactics, compute traffic time T_{m,n}(v, T_{*}) of every road-segment, including intersection vehicle queue time and bus stop time of additional time, and then, calculate road-net eigen period P^{β}; 2) based on specified parameters, obtain directional vehicle queues of every road-segment, and compute intersection-queue time offsets trq of the vehicle queues of every road-segment of intersection based on intersection-queue time offsets law of pan-green-wave; 3) based on specified mode and parameters, the optimization tactics, and the intersection-queue time offsets trq of the vehicle queues, compute time offsets of convection polarized green-wave; 4) make interim of polarized green-wave using remainder of the polarized green-wave time offsets.

Another feature of the traffic signal polarized green-wave control method, is step S2 including: S25-1-1, convection two dimension green-wave eigen period's algorithm: using traffic times calculate road-net eigen period P^{β}=2*T^{β} (T^{β}, half period), includes steps, (a) dividing road-segments into groups according to their length in some similarity degree (algorithm omitted); (b) if between groups' length there exist similar integer multiple, then compute maximum error λ max among the groups' length, and then obtain corresponding their traffic time T_{m,n}(v, T_{*}) error λ max (v, T_{*}), as road-net convection green-wave eigen half period error parameters, according to (100−β)%=λ max, obtain β, where T^{β} is similar eigen half period; (c) design make λmax<=λ^{e}, λ^{e} is critical value of road-net convection green-wave eigen half period error, for an example, if λ^{e} needs less than 0.1, that's, λ^{e}=10%, where T^{β} is eigen half period; (d) design controlling parameters such as drive speed of road-segments to meet the half eigen period error.

Another feature of the traffic signal polarized green-wave control method, includes: S3, Run the polarized green-wave mode after running out the respective interim period of every intersection.

Another feature of the traffic signal polarized green-wave control method, is step S3 including: S31, polarized green-wave includes differential green-wave: when differential green-wave starts, run differential signals operations with differential green-wave sensors catching differentiable traffic information; said differential green-waves is signal technology that let coming vehicles at red light phase of a ratio-rules signal running in an intersection occupy the intersection's green light phase time with no vehicle and pass the intersection safety when said phases' vehicles information data_qh are detected within preset distance D^{d}; said differentiable traffic information means within preset detecting distance D^{d} coming traffic in phases of a ratio-rules signal running in an intersection are that red light phase have a vehicle and green light phase “no vehicle”, where the detecting distance D^{d} is small just enough for vehicle coming at regular speed of “no vehicle phase” to brake stop at stop line normally; said differential signals operations are that a ratio-rules signal running in an intersection takes as small as possible green light phase time Δt with “no vehicle” to red light phase time with a vehicle, where the switched small green light phase time Δt is small just enough for vehicle to pass intersection; when the Δt time occupation finish and no more differentiable traffic information, return polarized green-wave.

Another feature of the traffic signal polarized green-wave control method, is step S3 including: S31-1, Said differential operations includes priority order of multi phases with vehicles detected, 1) the phase currently occupied time firstly; 2) the phase currently occupying time secondly; 3) preset order then.

Another feature of the traffic signal polarized green-wave control method, is step S3 including: S31-2, Said differential green-wave sensors, including positioning devices such as mobile phone/satellite, traffic video, induction coils, magnetic induction, infra-red/ultrasonic, radars, are used to detect differentiable traffic information, that's, detect within preset distance D^{d} of every phase (multi lanes sharing phase, or, one lane controlled by multi phases) whether or not there is vehicle coming.

Another feature of the traffic signal polarized green-wave control method, is step S3 including: S32, polarized green-wave including optimization time interval: when optimization time interval starts, run “build period spectrum P^{e}_{m,n} of the polarized green wave”.

The advantages of the present invention are below: based on optimized green time ratio and period, construct a frame with period spectrum of multi polarized periods embedded differential green-wave that are good at dynamical changing phases for phase-changing traffic load and integrated with AI control method dynamically on line, which both provides concrete signal scheme/control methods of broad band traffic signal period/green time ratio to road-net that spreads very heavy traffic at some intersections of non-uniform traffic loads, and an interface frame for obtaining and dealing with traffic data/optimizing signals' parameters using AI tech dynamically on line; comparing to current traffic signal systems, waiting time is lessened by far more than 30%, efficiency of transportation is improved greatly; whose attributes as universal model easy to embed new signal technology such as Pan String, String Super-mode, Lined Mixture, Pan-Green-Wave, differential green-wave, and whose frame features embedding AI's methods may realize wider gain of double broadband, including special signals for bus, application prospect is broad.

### BRIEF DESCRIPTION OF THE DRAWINGS

FIG. 1 is a flowchart of a polarized green-wave control method;

FIG. 2 shows topological structure of a road-net with traffic signal polarized green-wave;

FIG. 3 is a road-net channel-B sequence diagram of two dimension polarized green-wave;

FIG. 4 is a road-net channel-6 sequence diagram of two dimension polarized green-wave;

FIG. 5 is a road-net channel-B sequence diagram of convection two dimension polarized green-wave;

FIG. 6 is a road-net channel-6 sequence diagram of convection two dimension polarized green-wave;

### LIST OF REFERENCE NUMERAL UTILIZED IN THE DRAWING

FIG. 2: topological structure of a road-net with traffic signal polarized green-wave, 2-1—2 groups of numbers {(0,A),(7,H)} are for position coordinates of roads, intersections in road-net, origin of the coordinates is (0,A), largest coordinates is (7,H), coordinates of an intersection is (#,*), *for horizontal roads, #for vertical roads; 2-2—roads, cross of roads is intersection equipped with multi-phases signal lights controlled by traffic control center; 2-3—distance between two intersections and drive time at set drive speed 45 km/hr and queue, where 575-46/—are road-segment length 575 meters, drive time 46 seconds, no queue data; 2-4—numbers in square brackets are for time-offset of numbers' upright intersections to source intersection; 2-5—concentric double circle is for source intersection of the circle's downright intersection whose time-offset of polarized green-wave is 0;

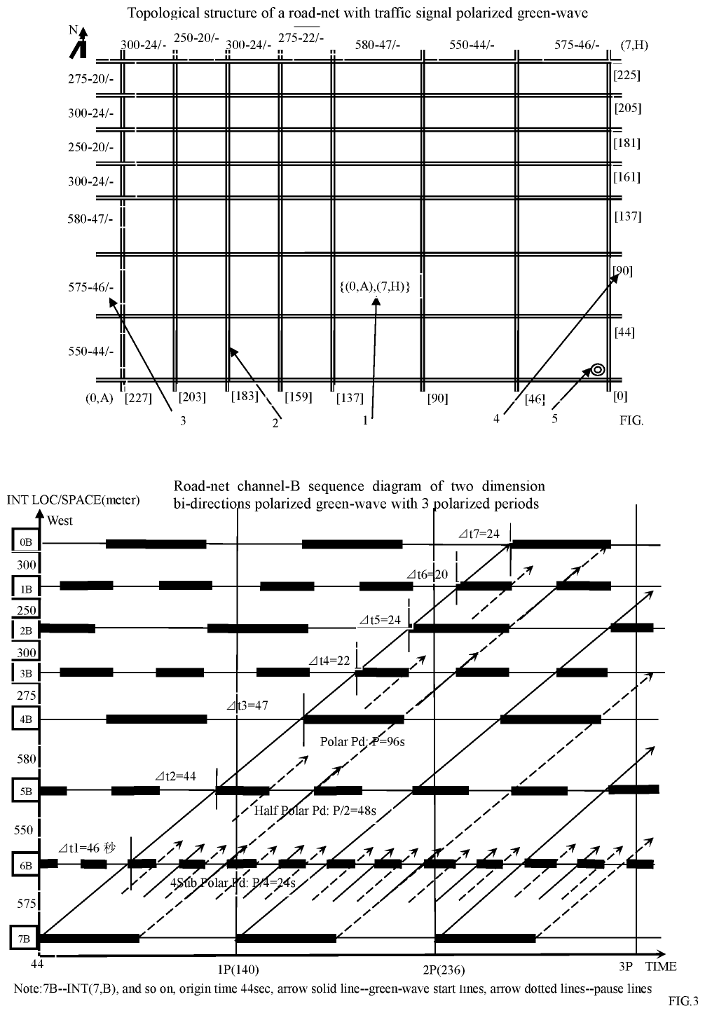

FIG. 3: road-net channel-B sequence diagram of two dimension bi-directions polarized green-wave with 3 polarized periods, at left of the diagram is a coordinate axis of intersections-between distances (SPACE) where there are 8 small squares with words for 8 intersections (INT) and their coordinates (LOC) of channel-B in road-net: INTs(0,B) to (7,B), and their-between distances (SPACE), such as distance between intersection 7B to intersection 6B is 575 meters; at bottom of the diagram is time axis in seconds, start point of axis is 44 seconds, whose length covers 3 polarized periods (Polar Pd) of P₀=96 seconds; thick black line segments in the diagram are for phase 2 (east-west phases) times and their volumes; blanks between thick black line segments are for phase 1 (south-north phases) times and their volumes; a thick black line segment plus a blank segment is a period, which includes two sub-periods, P₀/2=48 seconds, P₀/4=24 seconds; arrow solid lines label start lines of polarized green-wave window time of every intersections, arrow dotted lines label pause lines of polarized green-wave window time of every intersections, their slopes label that the time when vehicles driving at speed of 45 km/hr may meet green light; wherein shows 3 polarized periods with which form 3 different green-wave window times sections; what shows are two dimension bi-directions 3 polarized periods green-waves propagating from east to west in road-net channel-B of the road-net polarized green-waves;

FIG. 4: road-net channel-6 sequence diagram of two dimension bi-directions polarized green-wave with 3 polarized periods, shows polarized green waves propagating from south to north in road-net channel-6 of the road-net polarized green-waves in the same time when the polarized green waves propagating from east to west in road-net channel-B shown in FIG. 3;

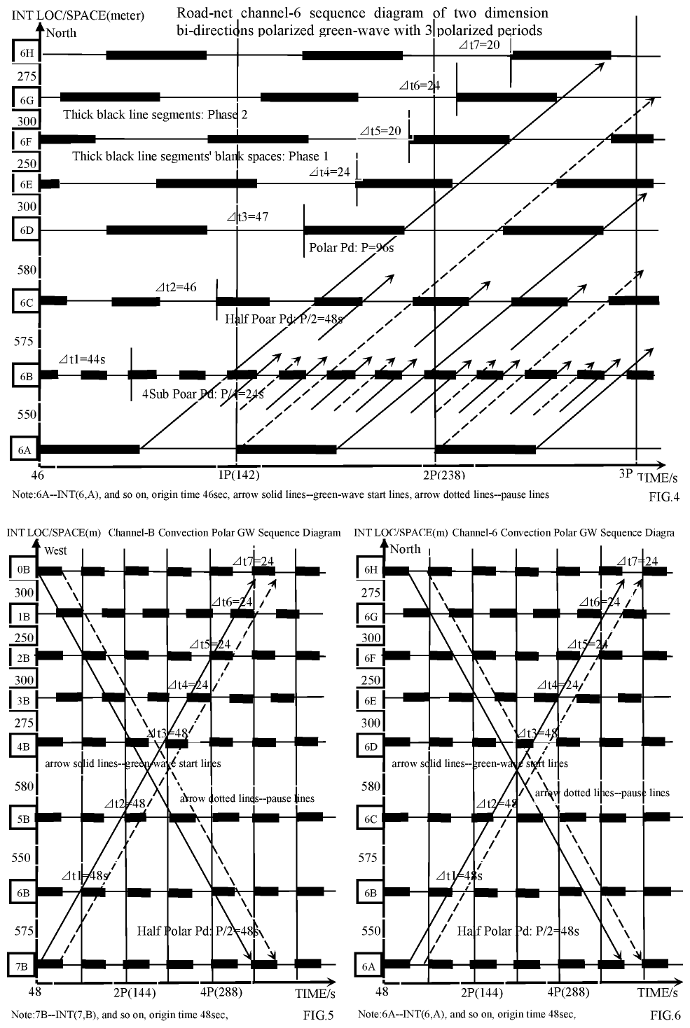

FIG. 5: road-net channel-B sequence diagram of convection two dimension 4-directions polarized green-wave, shows polarized green waves propagating simultaneously from east to west and from west to east in road-net channel-B of the road-net polarized green-waves (Polar GW);

FIG. 6: road-net channel-6 sequence diagram of convection two dimension 4-directions polarized green-wave, shows polarized green waves propagating simultaneously from south to north and from north to south in road-net channel-6 of the road-net polarized green-waves (Polar GW) in the same time when polarized green waves propagating simultaneously from east to west and from west to east in road-net channel-B of the road-net polarized green-waves (Polar GW) shown in FIG. 5;

### DETAILED DESCRIPTION OF THE INVENTION

### Description of the Preferred Embodiment, Industry Applications

A detailed description of 3 embodiment of the invention of polarized green-waves in conjunction with the accompanying drawings:

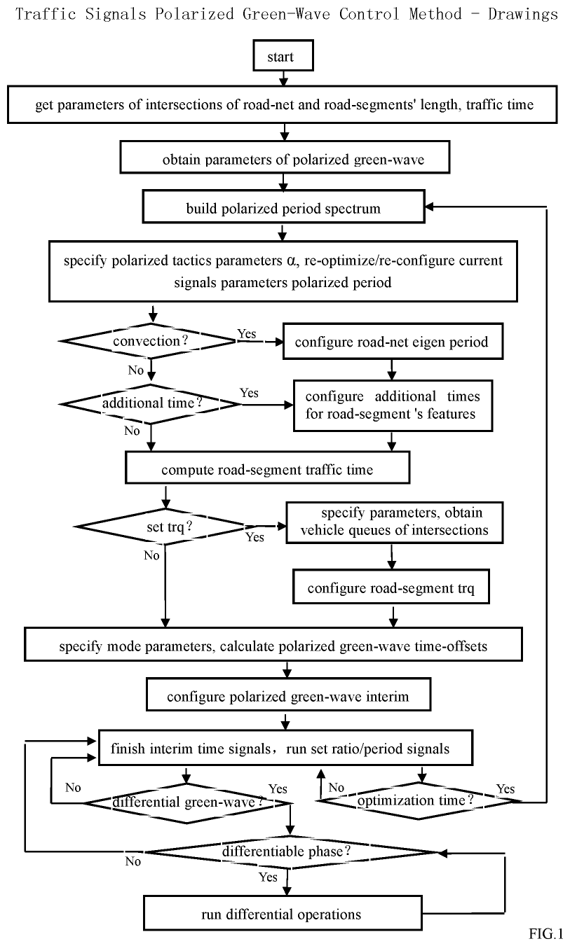

Embodiment 1, as shown in FIG. 2, implement traffic signal polarized green-wave control method as shown in FIG. 1 flow chart of polarized green-wave control method into traffic control center controlling road-net as FIG. 2;

Start step S1: get parameters of every intersection of the road-net, and distance/traffic time of every road-segment, including traffic signal parameters of every intersection, drive times as label 2-1 in FIG. 2, additional times not labeled;

S2, configure polarized green-wave mode: (1) obtain parameters of polarized green wave: 1) specify optimization algorithm of intersection signal—Webster Timing Method, ratio-rules' signal's parameters, period/green time ratio, traffic data used including traffic flow, arrival volume, historical data+periodical data, differential green-wave data, and their obtained method—traffic induction coils, optimization time interval; 2), omitted; 3) specify mode—two dimension bi-directions green-waves, its source intersection is at south-east corner in road-net with west as master direction and north as slave direction, as relative parameters; 4) specify additional time for traffic time of road-segments, omitted;

(2) build polarized period spectrum P^{e}_{m,n}: 1) according to specified optimization time interval, historical traffic data initially, signal parameters, optimization algorithm—Webster Timing Method, calculate phases' time and ratio-rules' parameters of every intersection, as result, Webster Timing periods P_{m,n}, of every intersection are obtained, as numbers shown in cell m/n of table 1; then, operate following periodical data optimization time interval+differential data time interval+historical data time interval;

TABLE 1
Webster Timing(Initial) and Polarized Period Optimization, Unit: second

| | | | | | | | | |
|---|---|---|---|---|---|---|---|---|
| H | 92, 46, 46 | 72, 36, 36 | 82, 42, 40 | 72, 36, 36 | 80, 33, 47 | 72, 36, 36 | 58, 26, 32 | 70, 28, 42 |
| | (96) [96] | (96) [96] | (96) [96] | (96) [96] | (96) [96] | (96) [96] | (96) [96] | (96) [96] |
| | {—}, 452 | {—}, 428 | {—}, 408 | {—}, 384 | {—}, 362 | {—}, 315 | {—}, 271 | {—}, 225 |
| | (68) | (44) | (24) | (0) | (76) | (27) | (75) | (33) |
| G | 80, 41, 39 | 71, 36, 35 | 72, 36, 36 | 68, 34, 34 | 72, 36, 36 | 44, 22, 22 | 70, 35, 35 | 92, 43, 49 |
| | (96) [96] | (96) [96] | (96) [96] | (96) [96] | (96) [96] | (48) [48] | (96) [96] | (96) [96] |
| | {—}, 432 | {—}, 408 | {—}, 388 | {—}, 364 | {—}, 342 | {—}, 295 | {—}, 251 | {—}, 205 |
| | (48) | (24) | (4) | (76) | (54) | (7) | (59) | (13) |
| F | 88, 45, 43 | 68, 35, 33 | 91, 45, 46 | 72, 36, 36 | 80, 33, 47 | 72, 36, 36 | 70, 35, 35 | 90, 43, 47 |
| | (96) [96] | (96) [96] | (96) [96] | (96) [96] | (96) [96] | (96) [96] | (96) [96] | (96) [96] |
| | {—}, 408 | {—}, 384 | {—}, 364 | {—}, 340 | {—}, 318 | {—}, 271 | {—}, 227 | {—}, 181 |
| | (24) | (0) | (76) | (52) | (30) | (79) | (35) | (85) |
| E | 80, 32, 48 | 78, 38, 40 | 91, | 83, 42, 41 | 68, 34, 34 | 44, 22, 22 | 70, 35, 35 | 88, 42, 46 |
| | (96) [96] | (96) [96] | 45, 46 | (96) [96] | (96) [96] | (48) [48] | (96) [96] | (96) [96] |
| | {—}, 388 | {—}, 364 | (96) [96] | {—}, 320 | {—}, 298 | {—}, 251 | {—}, 207 | {—}, 161 |
| | (4) | (76) | {—}, 344 | (32) | (10) | (59) | (15) | (65) |
| | | | (56) | | | | | |
| D | 90, 43, 47 | 78, 38, 40 | 92, 47, 45 | 66, 33, 33 | 80, 32, 48 | 60, 35, 25 | 80, 32, 48 | 90, 44, 46 |
| | (96) [96] | (96) [96] | (96) [96] | (96) [96] | (96) [96] | (96) [96] | (96) [96] | (96) [96] |
| | {—}, 364 | {—}, 340 | {—}, 320 | {—}, 296 | {—}, 274 | {—}, 227 | {—}, 183 | {—}, 137 |
| | (76) | (52) | (32) | (8) | (82) | (35) | (87) | (41) |
| C | 80, 48, 32 | 60, 35, 25 | 90, 47, 43 | 70, 35, 35 | 60, 30, 30 | 44, 22, 22 | 44, 21, 23 | 60, 28, 32 |
| | (96) [96] | (96) [96] | (96) [96] | (96) [96] | (96) [96] | (48) [48] | (48) [48] | (96) [96] |
| | {—}, 317 | {—}, 293 | {—}, 273 | {—}, 249 | {—}, 227 | {—}, 180 | {—}, 136 | {—}, 90 |
| | (29) | (5) | (81) | (57) | (35) | (84) | (40) | (90) |
| B | 70, 37, 33 | 44, 24, 20 | 60, 37, 23 | 44, 24, 20 | 60, 35, 25 | 30, 16, 14 | 24, 12, 12 | 58, 28, 30 |
| | (96) [96] | (48) [48] | (96) [96] | (48) [48] | (96) [96] | (48) [48] | (24) [24] | (96) [96] |
| | {—}, 271 | {—}, 247 | {—}, 227 | {—}, 203 | {—}, 181 | {—}, 134 | {—}, 90 | {—}, 44 |
| | (27) | (27) | (27) | (27) | (27) | (27) | (27) | (44) |
| A | 60, 38, 22 | 58, 32, 26 | 70, 38, 32 | 80, 48, 32 | 90, 47, 43 | 66, 33, 33 | 76, 38, 38 | 92, 46, 46 |
| | (96) [96] | (96) [96] | (96) [96] | (96) [96] | (96) [96] | (96) [96] | (96) [96] | (96) [96] |
| | {—}, 227 | {—}, 203 | {—}, 183 | {—}, 159 | {—}, 137 | {—}, 90 | {—}, 46 | {—}, 0 |
| | (35) | (11) | (87) | (63) | (41) | (90) | (46) | (0) |
| m/n | 0 | 1 | 2 | 3 | 4 | 5 | 6 | 7 |

Note:
1. digital 0-7 at bottom of the table 1 correspond to 8 horizontal (column) coordinates of vertical road channels and related intersections, letter A-H at left of the table 1 correspond to 8 vertical (row) coordinates of horizontal road channels and related intersections; in a cell of cross of column/row coordinates m/n, first line of numbers are for period time, phase1 time, phase2 time, where period time = phase1 time + phase2 time, phase1 for south/north directions, phase2 for east/west directions;
2. phase# is composed of shunt sub-phases, such as straight/left/right sub-phases of phase#, further expressed as phase#1, phase#2, phase#3; the other lines of numbers' meaning in cells will be given out in below;

2) take sum of biggest phase times Tₘ₋ₘₐₓ=47, T_{n,max}=49 among all period P_{m,n}, of two cross direction, as polarized period P₀=Tₘ₋ₘₐₓ+Tₙ₋ₘₐₓ=47+49=96;

3) divide the polarized period P₀ into series of sub-periods Pₘₐₓ/1, Pₘₐₓ/2, Pₘₐₓ/3 (or Pₘₐₓ/4), . . . , as polarized period spectrum of Pₘₐₓ/1=96, Pₘₐₓ/2=48, Pₘₐₓ/4=24, taking their carry integers when the number is not integer, which satisfy requirement of minimum period, Pₘₐₓ/1=96, Pₘₐₓ/2=48, Pₘₐₓ/4=24;

4), magnifying period P_{m,n}, of every intersection to the one of period spectrum Pₘₐₓ/1, Pₘₐₓ/2, Pₘₐₓ/4, . . . that is closest to the P_{m,n}, as their respectively upper limit, make periods P^{e}_{m,n} of every intersection, the numbers in parentheses in table 1 are polarized periods of corresponding intersections, where polarized periods of intersections B1, B3, B5, C5, C6, G5, E5 are 48 seconds, B6 is 24 sec, the others are 96 sec;

(3) decide tactics of the polarized periods: 3 periods distribution, the biggest period P₀=96 as basic timing period;

(4) predict polarized periods optimized: predict current signals and re-optimize, configure the polarized periods P^{e}_{m,n}, including said optimization tactics of polarized periods, in term of specified non-convection mode and mean method as its parameters a artificial intelligence method, re-optimized polarized periods P^{e}_{m,n} are obtained, as numbers shown in square brackets in cells of table 1;

(5) configure the polarized periods and their interim periods: 1) based on specified parameters of the non-convection mode and the 3 periods distribution optimization tactics, compute traffic time T_{m,n}(v, T_{*}) of every road-segment of road-net, as numbers labeled in FIG. 2, where v=12.5 m/s (speed per hour 45 km/h);

2) based on specified parameters—no vehicle queue data, not compute intersection-queue time offsets trq of the vehicle queues; (Trq=0.08*d−0.26*q), as “-” shown in parentheses of table 1 and FIG. 2;

3) based on specified mode—two dimension bi-directions green-waves, traffic time—drive time, and parameters, the optimization tactics—3 periods distribution, compute time offsets of polarized green-wave, as black numbers shown in cells of table 1, and as numbers labeled in FIG. 2; where T^{β}(v,*)|_{v=12.5};

4) make interim of polarized green-wave using remainder of the polarized green-wave time offsets, as black numbers in brackets in cells of table 1, whose master time-offsets/slave time-offsets are as numbers labeled at bottom and right respectively in FIG. 2; FIG. 3 shows two dimension bi-directions polarized green-waves sequence diagram in road-net channel-B, FIG. 4 shows two dimension bi-directions polarized green-waves sequence diagram in road-net channel-6 of same polarized green-waves as shown in FIG. 3;

S3, Run the polarized green-wave mode after running out the respective interim signals of polarized green-wave of every intersection; meanwhile,

(1) differential green-wave: when differential green-wave sensors detect vehicle coming information data_qh within preset distance D^{d}=50 in red light phase, let the red light phase with vehicle occupy current green light phase time with no vehicle by Δt=6 seconds to pass the intersection; when there are multi phases with vehicles coming detected, let the phase with time occupied get green light firstly, secondly let the phase with green light keep going on, then, let phase get green light on preset turn order; when no vehicle coming on, current phase run out its occupying time Δt=6 sec, return to the polarized green-wave; where the differential green-wave sensors use vehicle position device, or traffic video surveillance, and radars;

(2) optimization time interval: when optimization time interval starts, run “build period spectrum P^{e}_{m,n} of the polarized green wave”;

Embodiment 2, implement traffic signal polarized green-wave control method as shown in FIG. 1 flow chart of polarized green-wave control method into traffic control center controlling road-net as FIG. 2, create convection two dimension 4-directions polarized green-waves whose source intersection is at south-east corner of the road-net, master direction is west and slave direction north, the other specified parameters are same as embodiment 1, below are different (3) of step 2 configure polarized green-wave mode and its followings;

(3) decide tactics of the polarized periods: single period in whole road-net, 2-sub period P₀/2=48 as basic timing period;

(4) predict polarized periods optimized: no predict and re-optimize, configure the polarized periods P^{e}_{m,n}, in term of specified non-convection mode, the polarized periods P^{e}_{m,n} are obtained, as numbers shown in square brackets in cells of table 1;

(5) configure the polarized periods and their interims: 1) based on specified parameters of the convection mode and single period, compute traffic time T_{m,n}(v, T_{*}) of every road-segment of road-net, as numbers labeled in FIG. 2, where v=12.5 m/s (speed per hour 45 km/h);

1-1) design/compute road-net eigen period for convection two dimensions 4-directions polarized green-waves: (a) divide road-segments into two groups, group 1 average length+error: 568.33+18.33, λ₁=0.03; group 2 average length+error: 281.25+31.25, λ₂=0.11, λ₁<λ₂<0.12; (b) the two groups' average lengths exists two times relation, that's, 568/281=2.02; (c) set λ^{e}=12>=λ max; β=88; compute the road-net eigen period using traffic time T^{β}(v, T_{*})|_{v=12.5},

T^{β}(v,T_{*})|_{v=12.5}=(568.33+281.2)/3/12.5=283.19/12.5=23,P^{β}=46 s(45 km/h)

1-2) optimization tactics: single period, Pₘₐₓ/2=48 s, as numbers shown in square brackets of table 2 corresponding to polarized period of every intersection;

2) based on specified parameters of no vehicle queue data;

3) based on specified mode—convection two dimension 4-directions green-waves, traffic time—drive time, and said other related parameters, the optimization tactics—single period, compute time-offsets of the polarized green-wave, as black numbers in cells of table 2;

TABLE 2
Convection two dimension 4-direction polarized green-wave time offsets-Period 48 s

| | | | | | | | | |
|---|---|---|---|---|---|---|---|---|
| H | 480 (0) | 456 (24) | 432 (0) | 408 (24) | 384 (0) | 336 (0) | 288 (0) | 240 (0) |
| G | 456 (24) | 432 (0) | 408 (24) | 384 (0) | 360 (24) | 312 (24) | 264 (24) | 216 (24) |
| F | 432 (0) | 408 (24) | 384 (0) | 360 (24) | 336 (0) | 288 (0) | 240 (0) | 192 (0) |
| E | 408 (24) | 384 (0) | 360 (24) | 336 (0) | 312 (24) | 264 (24) | 216 (24) | 168 (24) |
| D | 384 (0) | 360 (24) | 336 (0) | 312 (24) | 288 (0) | 240 (0) | 192 (0) | 144 (0) |
| C | 336 (0) | 312 (24) | 288 (0) | 264 (24) | 240 (0) | 192 (0) | 144 (0) | 96 (0) |
| B | 288 (0) | 264 (24) | 240 (0) | 216 (24) | 192 (0) | 144 (0) | 96 (0) | 48 (0) |
| A | 240 (0) | 216 (24) | 192 (0) | 168 (24) | 144 (0) | 96 (0) | 48 (0) | 0 (0) |
| m/n | 0 | 1 | 2 | 3 | 4 | 5 | 6 | 7 |

4) make interim of polarized green-wave using remainder of the polarized green-wave time offsets, as black numbers in brackets in cells of table 1, whose master time-offsets/slave time-offsets are as numbers labeled at bottom and right respectively in FIG. 2; FIG. 5 shows convection two dimension 4-directions polarized green-waves sequence diagram in road-net channel-B, FIG. 6 shows convection two dimension 4-directions polarized green-waves sequence diagram in road-net channel-6 of same polarized green-waves shown in FIG. 5;

Embodiment 3, specify multi application periods compatible as its tactics in Embodiment 2, adjust and compute traffic time and additional times of road-segments by T^{β}(v, T_{*})|ᵥ, by integrating polarized periods and road-net eigen period, implement polarized green-waves that are general traffic and bus traffic compatible, and more applications;

1-1) design/compute road-net eigen period for convection two dimensions 4 directions polarized green-waves: (a) divide road-segments into two groups, group 1 average length+error: 568.33+18.33, λ₁=0.03; group 2 average length+error: 281.25+31.25, λ₂=0.11, λ₁<λ₂<0.12; (b) the two groups' average lengths exists two times relation, that's, 568/281=2.02; (c) set λ^{e}=12>=λmax; β=88; compute the road-net eigen period using traffic time T^{β}(v, T_{*})|_{v=12.5},

T^{β}(v,T_{*})|_{v=12.5}=(568.33+281.2)/3/12.5=283.19/12.5=23,P^{β}=46 s(45 km/h);

T^{β}(v,T_{*})_{v=11.11}=(568.33+281.2)/3/11.11=283.19/11.11=26,P^{β}=52 s(40 km/h);

T^{β}(v,T_{*})|_{v=8.66}=(568.33+281.2)/3/8.33=283.19/8.33=68,P^{β}=68 s (30 km/h);

1-2) optimization tactics: multi period compatible, Pₘₐₓ/2=48 s; as general traffic and bus traffic compatible green-wave period, as numbers in square brackets of table 2; in addition, by adding bus stop time “*”30 s to 40 s to additional time, specifying bus drive speed 30 km/h to 40 km/h, arrange a stop in every road-segment, adjusting traffic time T^{β}(v, T_{*})|ᵥ of every road-segment, for an example, assign bus stop time 30-40 sec, longer stop time in higher density road-net, make bus traffic convection period in 72 s to 96 s, in order match one period, 48 s, of said convection two dimension 4-directions polarized period spectrum some integer multiple, that's, compatible both;

What is claimed as new and desired to be protected by Letters Patent is set forth in the following:

1. A traffic signal polarized green-wave control method includes steps:
S1, get parameters of every intersection and distance/traffic time of every road-segment of a road-net;
S2, configure polarized green-wave mode: (1) obtain parameters of polarized green wave: 1) specify optimization algorithm of intersection signal, ratio-rules-based signal's parameters, period/green time ratio, traffic data used and their obtained method including artificial intelligence (AI) method, optimization time interval; 2) specify method for obtaining and optimizing vehicle queues of intersection; 3) specify mode and relative parameters; 4) specify additional time for the traffic time of road-segments;
(2) build polarized period spectrum P^{e}_{m,n}: 1) according to specified optimization time interval, obtained traffic data, signal parameters, optimization algorithm, calculate phases' time and ratio-rules' parameters of every intersection, as result, periods P_{m,n} of every intersection are obtained, where m, n are coordinates of an intersection in road-net; 2) take sum of two biggest phase times Tₘ₋ₘₐₓ, Tₙ₋ₘₐₓ among all period P_{m,n} of two cross directions as polarized period P₀; 3) divide the polarized period P₀ into series of sub-periods, Pₘₐₓ/1, Pₘₐₓ/2, Pₘₐₓ/3 (or Pₘₐₓ/4), . . . , as period spectrum of the polarized period, or say polarized period spectrum, which satisfy requirement of minimum period; 4), magnifying period P_{m,n}, of every intersection to the one of the period spectrum that is closest to the P_{m,n}, or using the polarized period spectrum directly, make periods P^{e}_{m,n} of every intersection with corresponding phase ratios;
(3) decide tactics of the polarized periods: multi periods distribution, single period, multi periods compatible, or other comprehensive tactics;
(4) predict polarized periods optimized: predict, re-optimize, re-configure current signals parameters, periods P_{m,n} with their green time ratios, and polarized periods P^{e}_{m,n}, in term of specified mode and its parameters, a artificial intelligence method;
(5) configure the polarized periods and their interim periods: 1) based on specified parameters of the mode and the optimization tactics, compute traffic time of every road-segment, or, mode-specified road-net eigen period P^{β}; 2) based on specified parameters, obtain vehicle queues of every intersection, and compute intersection-queue time offsets trq of every vehicle queue based on intersection-queue time offsets law of pan-green-wave; 3) based on specified mode and parameters, the optimization tactics, and the intersection-queue time offsets trq of the vehicle queues of every road-segment, compute time offsets of polarized green-wave; 4) make interim of polarized green-wave using remainder of the polarized green-wave time offsets;
S3, Run the polarized green-wave mode after running out the respective interim period of every intersection; meanwhile,
(1) differential green-wave: when differential green-wave starts, run differential signals operations with differential green-wave sensors catching differentiable traffic information;
(2) optimization time interval: when optimization time interval starts, run “build period spectrum P^{e}_{m,n}, of the polarized green wave”;
Said road-net is a group of mutually crossing roads, wherein its crossing points with their every directions controlled with traffic signals, called as intersections, divide the roads into groups of road-segments, parallelly topologically;
Said ratio-rules' signal bases on a cycle time length so-called period and ratios dividing the period into traffic signals controlling phases, directions and straight/left/right, where the period is traffic signal phases' times' sum of every directions controlled of an intersection; when all intersections' traffic signals in an area run on ratio-rules synchronously, it is called mode RATIO;
Said artificial intelligence (AI) method includes Artificial Neuron Networks ANN, Chaos Time Series, Wavelet theory, Statistical Regression and Support Vector Machine SVM, Genetic Optimization GA, Particle Swarm Optimization PSO, Fuzzy Analysis and Information Granulation, A-A method, intelligence learning time-series analysis method, any predict/optimization method including empirical method; what are obtained by AI methods analyzing historical data and detected data in real time are intelligent data;
Said green-wave means such signal mode that traffic signal green lights among intersections based on said ratio-rule and preset orderly time-offsets run asynchronously, making green light signal propagate between intersections directionally, from a source intersection to the intersection's adjacent one with bigger time-offset; a green-wave with its propagating direction same as traffic direction controlled is Lead mode, one with its propagating direction reverse of traffic direction controlled is Release mode, including uni-direction one dimension green-wave, convection one dimension green-wave, cross bi-direction two dimension green-wave, convection two dimension green-wave, out-phase mixed lined green-wave; RATIO is a standing green-wave; said source intersection is an intersection of a green-wave set smallest time-offset comparing with all the other intersections in the green-wave road-net; source intersections of uni-direction green-wave, convection one dimension green-wave and out-phase mixed lines green-wave are at one end intersections of their green-wave channels, and source intersections of cross bi-directions green-wave and cross convection cross 4-directions green-waves are at corner intersections of their green-waves area;
Said interim period is sum of traffic signal green light interim times in all directions controlled, is period remainder of switch time-offset of new mode comparing with current mode, in which traffic signal mode of an intersection changes from current mode to new mode smoothly without redundant time; Said remainder is period remainder, =remainder (time−offset % period); Said complement is period complement, =period−remainder; Said time-off is a delay of an intersection period comparing with a mode source intersection period, related to cared distance and traffic time, is sum of all related road-segments' traffic times from a source intersection of a green-wave to a specified downstream intersection of the green-wave.

2. A traffic signal polarized green-wave control method as in claim 1, wherein step S2 includes: S21, Said traffic data detectors, including positioning devices such as mobile phone/satellite, traffic video, induction coils, magnetic induction, infra-red/ultrasonic, radars, are used to detect traffic data of every phase (multi lanes sharing same phase or one lane controlled for multi phases), including vehicle queue tail data_qb.

3. A traffic signal polarized green-wave control method as in claim 1, wherein step S2 includes: S22, build polarized period spectrum P^{e}_{m,n}: 1) according to specified optimization time interval, obtained traffic data, signal parameters, optimization algorithm, calculate phases' time and ratio-rules' parameters of every intersection, as result, periods P_{m,n} of every intersection are obtained, where m, n are coordinates of an intersection in road-net; 2) take sum of two biggest phase times Tₘ₋ₘₐₓ, Tₙ₋ₘₐₓ among all period P_{m,n} of two cross directions as polarized period P₀; 3) divide the polarized period P₀ into series of sub-periods, Pₘₐₓ/1, Pₘₐₓ/2, Pₘₐₓ/3 (or Pₘₐₓ/4), . . . , as period spectrum of the polarized period, or say polarized period spectrum, which satisfy requirement of minimum period; 4), magnifying period P_{m,n}, of every intersection to the one of the period spectrum that is closest to the P_{m,n}, or using the polarized period spectrum directly, make periods P^{e}_{m,n} of every intersection with corresponding phase ratios.

4. A traffic signal polarized green-wave control method as in claim 1, wherein step S2 includes: S23, decide tactics of the polarized periods are rules of choice of which group of periods of polarized period spectrum are used to base configuring green-wave time-offsets in order to optimize traffic time: multi periods distribution, single period, multi application period compatible, or other comprehensive tactics.

5. A traffic signal polarized green-wave control method as in claim 1, wherein step S2 includes: S24, predict polarized periods optimized: predict, re-optimize, re-configure current signals parameters, periods P_{m,n} with their green time ratios, and polarized periods P^{e}_{m,n}, in term of specified mode and its parameters, a artificial intelligence method; said α artificial intelligence method is specially used to further optimize intersection signal parameters already optimized by traffic data.

6. A traffic signal polarized green-wave control method as in claim 1, wherein step S2 includes: S25, configure the polarized periods and their interim periods: 1) based on specified parameters of the mode and the optimization tactics, compute traffic time T_{m,n}(v, T_{*}) of every road-segment, or, mode-specified road-net eigen period P^{β}; 2) based on specified parameters, obtain vehicle queues of every intersection, and, compute intersection-queue time offsets trq of every vehicle queue based on intersection-queue time offsets law of pan-green-wave; 3) based on specified mode and parameters, the optimization tactics, and the intersection-queue time offsets trq of the vehicle queues of every road-segment, compute time offsets of polarized green-wave; 4) make interim of polarized green-wave using remainder of the polarized green-wave time offsets;
Said road-net eigen period means road-net feature related signal period required by special signal modes, for an example, convection signal mode requires period integer multiple of road-net eigen period; assume road-net eigen period P^{β}, where β is smaller than or equal to 100, stands for the period P^{β}'s percentage similarity to theoretical eigen period, such as β=85, means period P^{β} is 85% similarity to theoretical eigen period, β=100 means theoretical eigen period; P^{β} are a function P^{β}(v, T_{*}) of set drive speed v and additional time T^{*}.

7. A traffic signal polarized green-wave control method as in claim 1, wherein step S2 includes: S23-1-1, said multi periods distribution of polarized period's tactics, means that based on one period of polarized period spectrum configure some other periods of the polarized period spectrum to intersections distributed around road-net, construct embedded local green-wave in basic period green-wave.

8. A traffic signal polarized green-wave control method as in claim 1, wherein step S2 includes: S23-1-2, Said multi periods compatible of polarized period's tactics, means that based on one period of period spectrum, configure some other periods of the period spectrum distributed to intersections around road-net, construct embedded convection green-wave whose period are integer multiples of basic green-wave period forming multi global green-waves compatible, in term of road-net features and traffic features, for special application with special drive speed v and additional time T of special traffic time T_{m,n}(v, T_{*}), such as bus speed, bus stop positions and bus stop time.

9. A traffic signal polarized green-wave control method as in claim 1, wherein step S2 includes: S25-1, configure convection two dimension polarized green-wave periods and their interim periods: 1) based on specified parameters of the mode and the optimization tactics, compute traffic time T_{m,n}(v, T_{*}) of every road-segment, including intersection vehicle queue time and bus stop time of additional time, and then, calculate road-net eigen period P^{β}; 2) based on specified parameters, obtain directional vehicle queues of every road-segment, and compute intersection-queue time offsets trq of the vehicle queues of every road-segment of intersection based on intersection-queue time offsets law of pan-green-wave; 3) based on specified mode and parameters, the optimization tactics, and the intersection-queue time offsets trq of the vehicle queues, compute time offsets of convection polarized green-wave; 4) make interim of polarized green-wave using remainder of the polarized green-wave time offsets.

10. A traffic signal polarized green-wave control method as in claim 1, wherein step S5 includes: S25-1-1, convection two dimension green-wave eigen period's algorithm: using traffic times calculate road-net eigen period P^{β}=2*T^{β}(T^{β}, half period), includes steps, (a) dividing road-segments into groups according to their length in some similarity degree (algorithm omitted); (b) if between groups' length there exist similar integer multiple, then compute maximum error λ max among the groups' length, and then obtain corresponding their traffic time T_{m,n}(v, T_{*}) error λ max (v, T_{*}), as road-net convection green-wave eigen half period error parameters, according to (100−β) %=λ max, obtain β, where T^{β} is similar eigen half period; (c) design make λmax<=λ^{e}, λ^{e} is critical value of road-net convection green-wave eigen half period error, for an example, if λ^{e} needs less than 0.1, that's, λ^{e}=10%, where T^{β} is eigen half period; (d) design controlling parameters such as drive speed of road-segments to meet the half eigen period error.

11. A traffic signal polarized green-wave control method as in claim 1, wherein step S2 includes: S3, Run the polarized green-wave mode after running out the respective interim period of every intersection.

12. A traffic signal polarized green-wave control method as in claim 1, wherein step S2 includes: S31, polarized green-wave includes differential green-wave: when differential green-wave starts, run differential signals operations with differential green-wave sensors catching differentiable traffic information; said differential green-waves is signal technology that let coming vehicles at red light phase of a ratio-rules signal of an intersection occupy the intersection's green light phase time with no vehicle and pass the intersection safety when said phases' vehicles information data_qh are detected within preset distance D^{d}; said differentiable traffic information means within preset detecting distance D^{d} coming traffic in phases of a ratio-rules signal of an intersection is that red light phase have a vehicle and green light phase “no vehicle”, where the detecting distance D^{d} is small just enough for coming vehicle at regular speed of “no vehicle phase” to brake stop at stop line normally; said differential signals operations are that a ratio-rules signal of an intersection gives as small as possible green light phase time Δt with “no vehicle” to red light phase time with a vehicle, where the switched small green light phase time Δt is small just enough for vehicle to pass intersection; when the Δt time occupation finish and no more differentiable traffic information, return polarized green-wave.

13. A traffic signal polarized green-wave control method as in claim 1, wherein step S2 includes: S31-1, Said differential operations includes priority order of multi phases with vehicles detected, 1) the phase currently occupied time firstly; 2) the phase currently occupying time secondly; 3) preset order then.

14. A traffic signal polarized green-wave control method as in claim 1, wherein step S2 includes: S31-2, Said differential green-wave sensors, including positioning devices such as mobile phone/satellite, traffic video, induction coils, magnetic induction, infra-red/ultrasonic, radars, are used to detect differentiable traffic information, data_qh, that's, detect within preset distance D^{d} of every phase (multi lanes sharing phase, or, one lane controlled by multi phases) whether or not there is vehicle coming.

15. A traffic signal polarized green-wave control method as in claim 1, wherein step S2 includes: S32, polarized green-wave including optimization time interval: when optimization time interval starts, run “build period spectrum P^{e}_{m,n} of the polarized green wave”.
